(19) United States
(12) Patent Application Publication
(10) Pub. No.: US 2018/0260009 A1
(43) Pub. Date: Sep. 13, 2018

(54) APPARATUS FOR PROCESSING DATA, AND METHOD FOR OPERATING SUCH AN APPARATUS

(71) Applicant: SIEMENS AKTIENGESELLSCHAFT, München (DE)

(72) Inventor: Frank Roeder, Leipzig (DE)

(21) Appl. No.: 15/761,104

(22) PCT Filed: Aug. 9, 2016
(86) PCT No.: PCT/EP2016/068922

§ 371 Date: Mar. 18, 2018

(30) Foreign Application Priority Data
Sep. 18, 2015 (DE) 10 2015 217 933.8

(51) Int. Cl. G06F 1/24; G06F 1/26; G06F 9/4401; G06F 13/42; G06F 3/06; G06F 11/30

(52) U.S. Cl. CPC G06F 1/24; G06F 1/26; G06F 9/4403; G06F 11/30; G06F 3/0625; G06F 3/0629; G06F 3/0679; G06F 13/4282

(57) ABSTRACT

The invention relates to a device for processing data, comprising: a computing device, which can be booted by means of a determined boot block, for processing the data; a storage device, which can be operated by means of an operating voltage, for storing at least the boot block for booting the computing device; and a circuit for deactivating the operating voltage of the storage device according to at least one reset signal prompting a reset of the computing device. In this way, it is possible that, with each reset of the computing device, prompted or triggered by the at least one reset signal, the voltage supply is separated from the storage device and all registers in the storage device are thereby reset. The invention also relates to a method for operating a device for processing data, and an embedded system comprising a device of this type.

The present invention relates to an apparatus for processing data that comprises a computation apparatus, bootable by means of a particular boot block, for processing the data and a memory apparatus, operable by means of an operating voltage, for storing at least the boot block for booting the computation apparatus.

Moreover, the present invention relates to a method for operating such an apparatus and to an embedded system having such an apparatus.

In embedded systems having a computation apparatus, such as a CPU (Central Processing Unit), an FPGA (Field Programmable Gate Array) or an SoC FPGA (SoC; System on Chip), for example, the operating system and the data (or user data) are stored using what are known as SPI flash memories (SPI; Serial Program Interface). By way of example, QSPI stands for Quad Serial Program Interface and is a four-wire communication interface that is very fast and can therefore be used for fast boot processes. The boot block or the boot image for automated booting needs to be in the first 16 MB in any QSPI flash memory. This is necessary because the permanently implemented boot functions in FPGAs or CPUs require this. QSPI flash memories are virtually compatible with one another. The manufacturers of FPGAs use a standardized communication process in this regard in order to address the QSPI flash memories of the manufacturers during the boot process. This standardization for the boot process has been restricted to 16 MB.

Modern QSPI flash memories have up to 64 MB of memory, however. when QSPI flash memories having more than 16 MB are used, accessing them requires a specific register in the QSPI flash memory to have data written to it. After a boot process, it is accordingly necessary for this register to have data written to it in order to be able to write to or read up to 64 MB in the QSPI flash memory, for example.

When CPUs, FPGAs or SoC FPGAs are used, it is possible for them to enter the boot mode as a result of an external wanted or unwanted reset. Should the specific register in the QSPI flash memory already have been set for use of greater than 16 MB in this case, then the boot process initiated by the reset process fails because the boot block is in the first 16 MB. The boot process is then stopped and the apparatus comprising the computation apparatus and the memory apparatus is functionless. Only if the supply voltage (operating voltage) of the apparatus is switched off completely is the QSPI flash memory also reset and the boot process can take place from the first 16 MB of the QSPI flash memory.

Moreover, QSPI flash memories are now known that have an external reset input. These are new components with different transmission protocols, however. The external reset input is then operated by an additional CPLD chip (CPLD; Complex Programmable Logic Device) that evaluates all the possible external reset events and then operates the reset input of the QSPI flash memory. This is disadvantageously a disproportionately high level of outlay for resetting a memory apparatus, however.

Against this background, it is an object of the present invention to improve the resetting of a memory apparatus, in particular in an embedded system.

According to a first aspect, an apparatus for processing data is proposed that comprises a computation apparatus, bootable by means of a particular boot block, for processing the data, a memory apparatus, operable by means of an operating voltage, for storing at least the boot block for booting the computation apparatus and a circuit for switching off the operating voltage of the memory apparatus on the basis of at least one reset signal prompting a reset of the computation apparatus.

On every reset of the computation apparatus, prompted or triggered by the at least one reset signal, the power supply is isolated from the memory apparatus and hence all registers in the memory apparatus are reset.

Advantageously, this allows all conventional memory apparatuses, including those without a reset input of their own, to be easily reset with only little hardware outlay. Since it is not necessary to use an external reset input, it is advantageously possible for conventional communication protocols that are already programmed to continue to be used. There is therefore no need to change to a different memory apparatus or a different SPI protocol.

The apparatus is an embedded system, for example. The boot block can also be referred to as a boot image and is in particular stored in a particular boot sector of the memory apparatus. For the example of a QSPI flash memory as memory apparatus, the boot sector corresponds to the first 16 MB of the QSPI flash memory.

The operating voltage can also be referred to as a supply voltage.

The reset signal relates, by way of example, to an external power-on reset N that, by way of example, completely resets an SoC FPGA, and as a result, by way of example, a QSPI flash memory is isolated from its power supply during the reset phase. The reset signal can also relate to an external software reset N that resets only the CPU in an SoC FPGA, for example, while the FPGA itself remains executable, and as a result the QSPI flash memory is isolated from its power supply during the reset phase. This software reset can, by way of example, be initiated by a debugger.

The reset signal may also be generated by the computation apparatus itself. As a result of this reset triggered by the computation apparatus, the memory apparatus is isolated from the power supply during this phase. During this process, the computation apparatus itself is not reset, but rather continues to run. After this process, that is to say if the memory apparatus has reset all its registers again by means of the voltage interruption, the computation apparatus can initiate an internal self-reset of its own in order to begin a boot process.

According to one embodiment, the computation apparatus is an FPGA (Field Programmable Gate Array) or an SoC FPGA (System on Chip Field Programmable Gate Array).

The computation apparatus can also be referred to as a control apparatus, in particular if it is part of an embedded system and undertakes the control tasks or the functionality of the embedded system.

According to a further embodiment, the computation apparatus is a CPU (Central Processing Unit).

According to a further embodiment, the memory apparatus is a flash memory, in particular without a reset input.

According to a further embodiment, the memory apparatus is an SPI flash memory (SPI; Serial Programmable Interface).

According to a further embodiment, the memory apparatus is a QSPI flash memory, in particular without a reset input.

According to a further embodiment, the memory apparatus is a solderable micro-SD memory, in particular without a reset input.

According to a further embodiment, the memory apparatus is an eMMC memory, in particular without a reset input.

The eMMC memory (eMMC; embedded Multimedia Card) is an energy-saving and space-saving storage medium based on the MMC standard that has been developed for use as an internal data memory in mobile devices.

According to a further embodiment, the circuit is set up to switch off the operating voltage of the memory apparatus on the basis of a first reset signal generated by a first monitoring chip monitoring a cold start of the computation apparatus.

The first monitoring chip may be part of a reset chip inherently present on the embedded system.

According to a further embodiment, the circuit is set up to switch off the operating voltage of the memory apparatus on the basis of a second reset signal generated by a second monitoring chip monitoring a warm start of the computation apparatus. The second monitoring chip may be a debugger.

The respective unit, for example the first or the second monitoring chip, may be implemented on a hardware basis and/or also on a software basis. In the case of a hardware-based implementation, the respective unit may be configured as an apparatus or as part of an apparatus, for example as a computer or as a microprocessor or as an integrated circuit. In the case of a software-based implementation, the respective unit may be configured as a computer program product, as a function, as a routine, as part of a program code or as an executable object.

According to a further embodiment, the circuit is set up to switch off the operating voltage of the memory apparatus on the basis of a third reset signal generated by the computation apparatus.

According to a further embodiment, the circuit is set up to switch off the operating voltage of the memory apparatus on the basis of a first reset signal generated by a first monitoring chip monitoring a cold start of the computation apparatus, on the basis of a second reset signal generated by a second monitoring chip monitoring a warm start of the computation apparatus and on the basis of a third reset signal generated by the computation apparatus.

Table 1 below shows a clear depiction of the switching-off of the power supply of the memory apparatus and hence of the reset of the memory apparatus. The right-hand column of table 1 below shows the reset, a 1 denoting a reset and a 0 denoting no reset. The first three columns show the three reset signals R3, R1 and R2, H denoting a positive logic signal level and L denoting a negative logic signal level (H=high; L=low).

TABLE 1

| R3 | R1 | R2 | RESET |
|---|---|---|---|
| L | H | H | 0 |
| H | H | H | 1 |
| H | L | H | 1 |
| H | H | L | 1 |
| H | L | L | 1 |
| L | L | H | 1 |
| L | H | L | 1 |
| L | L | L | 1 |

According to a further embodiment, the circuit comprises a switching element that is set up to switch off the operating voltage of the memory apparatus if the first reset signal has a negative logic signal level L, if the second reset signal has a negative logic signal level L or if the third reset signal has a positive logic signal level H.

According to a further embodiment, the switching element is configured as a first pMOS transistor.

According to a further embodiment, the circuit comprises a first input node for receiving the first reset signal, a first pull-up resistor coupled between the first input node and an operating voltage node and a second pMOS transistor. The gate connection of the second pMOS transistor is connected to the first input node. The source connection of the second pMOS transistor is connected to the operating voltage node. The drain connection of the second pMOS transistor is connected to the gate connection of the first pMOS transistor.

The operating voltage node can also be referred to as a supply voltage node. The operating voltage (supply voltage) is applied between said operating voltage node and ground.

According to a further embodiment, the circuit comprises a second input node for receiving the second reset signal, a second pull-up resistor coupled between the second input node and the operating voltage node and a third pMOS transistor. In this case, the gate connection of the third pMOS transistor is connected to the second input node. Further, the source connection of the third pMOS transistor is connected to the operating voltage node. The drain connection of the third pMOS transistor is connected to the gate connection of the first pMOS transistor.

According to a further embodiment, the circuit comprises a third input node for receiving the third reset signal, a pull-down resistor coupled between the third input node and ground and a series resistor coupled between the third input node and the gate connection of the first pMOS transistor.

As explained above, the circuit for switching off the power supply of the memory apparatus on the basis of a reset of the computation apparatus necessitates only few additional hardware components, that is to say only three p-channel MOSFET transistors and a few resistors.

According to a second aspect, an embedded system is proposed. The embedded system comprises a number, in particular a plurality, of apparatuses according to the first aspect.

According to a third aspect, a method for operating an apparatus for processing data is proposed, wherein the apparatus comprises a computation apparatus, bootable by means of a particular boot block, for processing the data and a memory apparatus, operable by means of an operating voltage, for storing at least the boot block for booting the computation apparatus. The method has the following steps:

operating the apparatus such that the computation apparatus processes data, and
switching off the operating voltage of the memory apparatus on the basis of at least one reset signal prompting a reset of the computation apparatus.

The embodiments and features described for the proposed apparatus apply to the proposed method mutatis mutandis.

According to a further aspect, a computer program product is proposed that prompts the performance of the method according to the third aspect, as explained above, on a program-controlled device.

A computer program product, such as e.g. a computer program means, can, by way of example, be provided or supplied as a storage medium, such as e.g. a memory card, USB stick, CD-ROM, DVD, or else in the form of a downloadable file from a server in a network. This can take place in a wireless communication network, for example, by virtue of the transmission of an appropriate file with the computer program product or the computer program means.

Further possible implementations of the invention also encompass combinations, not mentioned explicitly, of features or embodiments as described above or below with respect to the exemplary embodiments. In this case, a person skilled in the art will also add individual aspects as improvements or augmentations to the respective basic form of the invention.

Further advantageous configurations and aspects of the invention are the subject matter of the subclaims and of the exemplary embodiments of the invention that are described below. The invention is explained in more detail below using preferred embodiments with reference to the accompanying figures.

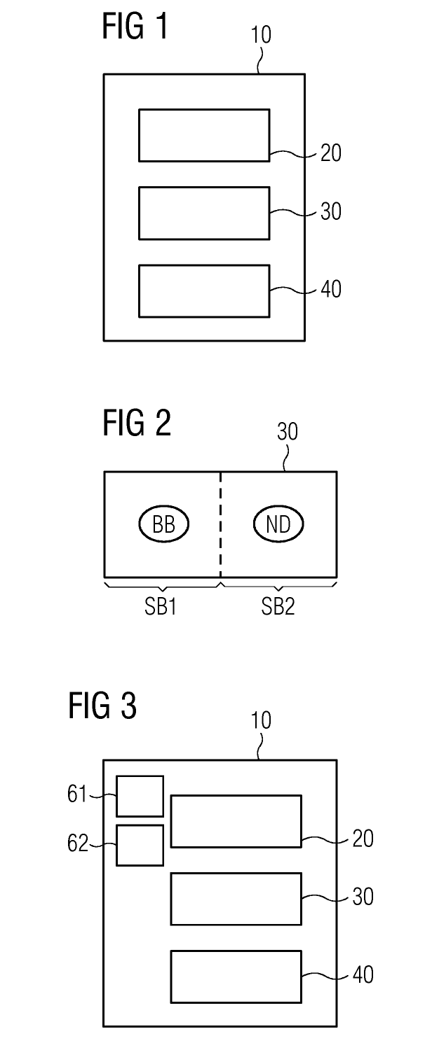

FIG. 1 shows a schematic block diagram of a first exemplary embodiment of an apparatus for processing data;

FIG. 2 shows a schematic block diagram of an exemplary embodiment of a memory apparatus for storing a boot block for booting the computation apparatus;

FIG. 3 shows a schematic block diagram of a second exemplary embodiment of an apparatus for processing data;

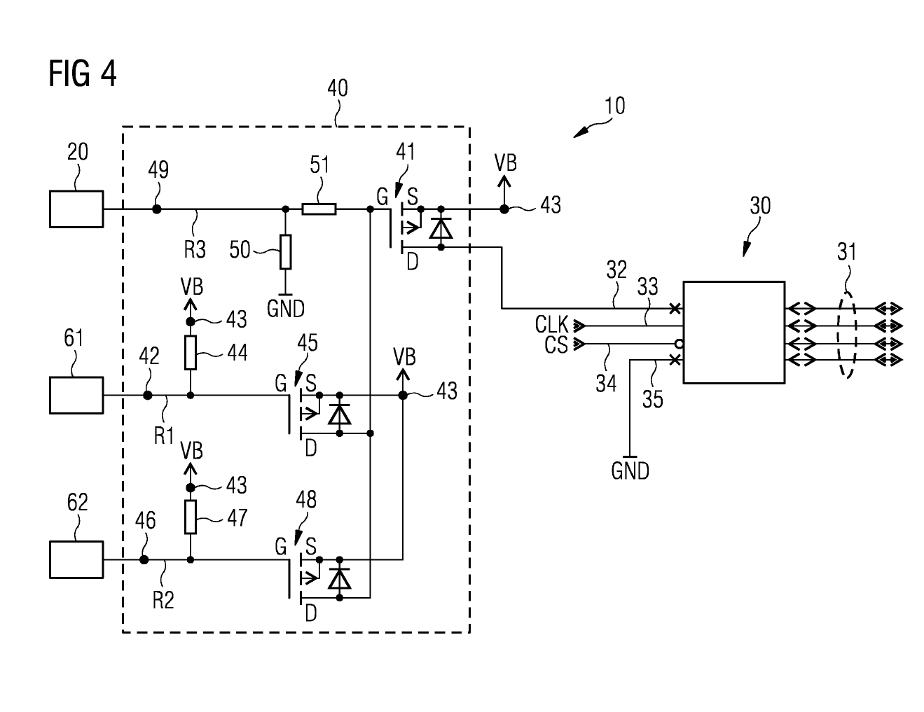

FIG. 4 shows a schematic block diagram of a third exemplary embodiment of an apparatus for processing data;

FIG. 5 shows a schematic block diagram of an exemplary embodiment of an embedded system; and

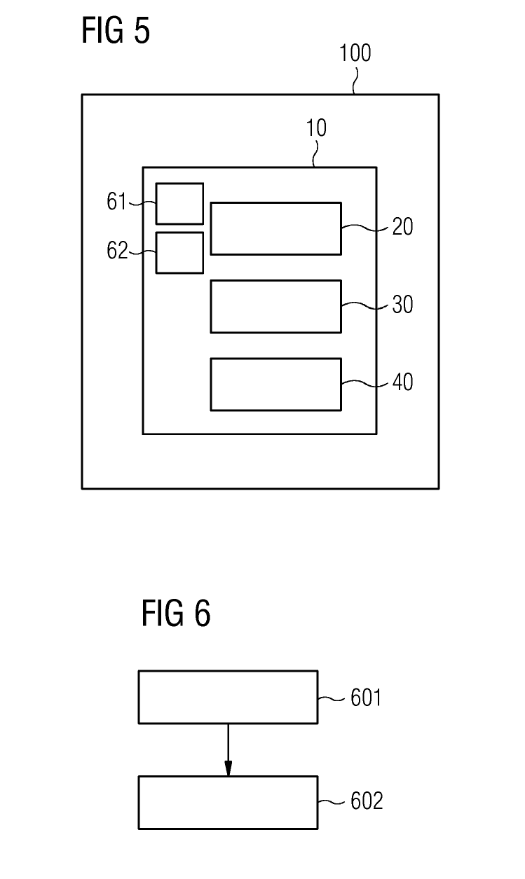

FIG. 6 shows a schematic flowchart for an exemplary embodiment of a method for operating an apparatus.

In the figures, elements that are the same or have the same function have been provided with the same reference symbols, unless indicated otherwise.

FIG. 1 shows a schematic block diagram of a first exemplary embodiment of an apparatus 10 for processing data or useful data ND.

The apparatus 10 comprises a computation apparatus 20 for processing the data ND, a memory apparatus 30 and a circuit 40.

The computation apparatus 20 is bootable by means of a particular boot block BB. The memory apparatus 30 stores at least this particular boot block BB for booting the computation apparatus 20. To this end, FIG. 2 shows a schematic block diagram of an exemplary embodiment of a memory apparatus 30. The memory apparatus 30 comprises a first memory area SB1, for example the first 16 MB, and a second memory area SB2, for example the second 16 MB. After booting, a register changeover is possible if the second memory area SB2 is also supposed to have data written to it. The register changeover can also be performed by the computation apparatus 20.

The computation apparatus 20 is, by way of example, an FPGA, an SoC FPGA or a CPU. The memory apparatus 30 is, by way of example, a flash memory, an SPI flash memory, a QSPI flash memory, a solderable micro-SD memory or an eMMC memory. In particular, the memory apparatus 30 is a QSPI flash memory without a specifically present reset input.

The circuit 40 of the apparatus 10 is set up to switch off the operating voltage VB (for example see FIG. 4) of the memory apparatus 30 on the basis of at least one reset signal R1, R2, R3 prompting a reset of the computation apparatus 20. The switching-off of the operating voltage VB of the memory apparatus 30 causes a reset of the memory apparatus 30. Consequently, a reset of the memory apparatus 30 is possible even if the memory apparatus 30 itself has no specifically provided reset input or reset connection.

FIG. 3 depicts a schematic block diagram of a second exemplary embodiment of an apparatus 10 for processing data ND. The second exemplary embodiment of the apparatus 10 of FIG. 3 comprises all the features of the first exemplary embodiment of FIG. 1. Furthermore, the apparatus 10 of FIG. 3 has a first monitoring chip 61, which monitors a cold start of the computation apparatus 20, and a second monitoring chip 62, which monitors a warm start of the computation apparatus 20.

In the second exemplary embodiment of FIG. 3, the circuit 40 is set up to switch off the operating voltage VB of the memory apparatus 30 on the basis of a first reset signal R1, generated by the first monitoring chip 61, for resetting the computation apparatus 20, on the basis of a second reset signal R2, generated by the second monitoring chip 62, for resetting the computation apparatus 20 and on the basis of a third reset signal R3, generated by the computation apparatus 20, for resetting the computation apparatus 20.

Consequently, in the second exemplary embodiment of FIG. 3, three different sources exist for a reset signal R1, R2, R3 for resetting the computation apparatus 20, the respective reset signal R1, R2, R3 causing the operating voltage VB of the memory apparatus 30 to be switched off and hence the memory apparatus 30 to be reset. Details in this regard can be found in FIG. 4 and the description relating thereto.

FIG. 4 shows a schematic block diagram of a third exemplary embodiment of an apparatus 10 for processing data ND. The third exemplary embodiment of FIG. 4 is based on the second exemplary embodiment of FIG. 3 and has all of the features of the second exemplary embodiment of FIG. 3.

The memory apparatus 30 of FIG. 4 is a QSPI flash memory having four wires 31 for four-wire communication.

Moreover, the QSPI flash memory 30 of FIG. 4 has connections 32 for supply with operating voltage VB, connections 33 for clock signals CLK, connections 34 for CS signals (CS; Chip-Select) and connections 35 for coupling to ground GND.

The connection 32 of the flash memory 30 is connected via a first pMOS transistor 41 of the circuit 40 to an operating voltage node 43 that is connected to an operating voltage source, and consequently can supply the flash memory 30 with the operating voltage VB.

The first pMOS transistor 41 is set up to switch off the operating voltage VB of the memory apparatus 30 if the first reset signal R1, which is provided by the first monitoring chip 61, has a negative logic signal level L, if the second reset signal R2, which is provided by the second monitoring chip 62, has a negative logic signal level L or if the third reset signal R3, which is provided by the computation apparatus 20 itself, has a positive logic signal level H.

To this end, the circuit 40 comprises a first input node 42 for receiving the first reset signal R1, a first pull-up resistor 44 coupled between the first input node 42 and the operating voltage node 43 and a second pMOS transistor 45. The gate connection G of the second pMOS transistor 45 is connected to the first input node 42, which in turn is coupled to the first monitoring chip 61. The source connection S of the second pMOS transistor 45 is connected to the operating voltage node 43, and the drain connection D of the second pMOS transistor 45 is connected to the gate connection G of the first pMOS transistor 41.

If the first reset signal R1 assumes a negative logic signal level L, then the gate G of the second pMOS transistor 45 also has L applied to it, the drain-source path of the second pMOS transistor 45 turns on and the gate of the first pMOS transistor 41 assumes a positive logic signal level H. Owing to the positive logic signal level H on the gate connection G of the first pMOS transistor 41, the drain-source path of the first pMOS transistor 41 is turned off and the operating voltage VB can no longer be supplied to the flash memory 30.

Moreover, the circuit 40 has a second input node 46 for receiving the second reset signal R2, a second pull-up resistor 47 coupled between the second input node 46 and the operating voltage node 43 and a third pMOS transistor 48. In this case, the gate connection G of the third pMOS transistor 48 is connected to the second input node 46, the source connection S of the third pMOS transistor 48 is connected to the operating voltage node 43 and the drain connection D of the third pMOS transistor 48 is connected to the gate connection G of the first pMOS transistor 41.

If the second reset signal R2 assumes a negative logic signal level L, then the gate G of the third pMOS transistor 48 also has L applied to it, the drain-source path of the third pMOS transistor 48 turns on and the gate of the first pMOS transistor 41 assumes a positive logic signal level H. Owing to the positive logic signal level H on the gate connection G of the first pMOS transistor 41, the drain-source path of the first pMOS transistor 41 is turned off and the operating voltage VB can no longer be supplied to the flash memory 30.

Further, the circuit 40 has a third input node 49 for receiving the third reset signal R3. The third input node 49 is coupled to the computation apparatus 20. The third input node 49 and ground GND have a pull-down resistor 50 coupled between them. The third input node 49 and the gate connection G of the first pMOS transistor 41 have a series resistor 51 coupled between them. If the third reset signal R3 assumes a positive logic signal level H, then the gate connection G of the first pMOS transistor 41 also has a positive logic signal level H applied to it, which means that the drain-source path of the first pMOS transistor 41 is turned off and the flash memory 30 can no longer be supplied with the operating voltage VB. Consequently, the flash memory 30 is reset in this case too.

FIG. 5 shows a schematic block diagram of an exemplary embodiment of an embedded system 100. The embedded system 100 comprises the apparatus 10 shown in FIG. 3. Alternatively, the embedded system 100 can also comprise the apparatus 10 of FIG. 1 or the apparatus 10 of FIG. 4. Moreover, the embedded system 100 can also comprise a plurality of apparatuses 10 as shown in FIG. 1, as shown in FIG. 3 or as shown in FIG. 4.

FIG. 6 depicts a schematic flowchart for an exemplary embodiment of a method for operating an apparatus 10 for processing data ND. The apparatus 10 is configured, by way of example, as shown in FIG. 1, as shown in FIG. 3 or as shown in FIG. 4. The method of FIG. 6 comprises steps 601 and 602.

In step 601, the apparatus 10 is operated such that the computation apparatus 20 processes data.

In step 602, the operating voltage VB of the memory apparatus 30 is switched off on the basis of at least one reset signal R1, R2, R3 prompting a reset of the computation apparatus 20. The switching-off of the operating voltage VB of the memory apparatus 30 causes the memory apparatus 30 to be reset.

Although the present invention has been described on the basis of exemplary embodiments, it is modifiable in many and diverse ways.

1. An apparatus for processing data, the apparatus comprising:
a computer bootable by a particular boot block for processing the data;
a memory operable by an operating voltage, the memory being configured to store at least the particular boot block for booting the computation apparatus; and
a circuit configured to switch off the operating voltage of the memory based on at least one reset signal prompting a reset of the computer.

2. The apparatus of claim 1, wherein the computer is a field-programmable gate array (FPGA), a system on a chip (SOC) FPGA, or a central processing unit (CPU).

3. The apparatus of claim 1, wherein the memory is a flash memory, a QSPI flash memory, a solderable micro-SD memory, or an embedded MultiMediaCard (eMMC) memory.

4. The apparatus of claim 1, wherein the memory is a quad serial peripheral interface (QSPI) flash memory without a reset input.

5. The apparatus of claim 1, wherein the circuit is configured to switch off the operating voltage of the memory based on a reset signal generated by a monitoring chip monitoring a cold start of the computer.

6. The apparatus of claim 1, wherein the circuit is configured to switch off the operating voltage of the memory based on a reset signal generated by a monitoring chip monitoring a warm start of the computation computer.

7. The apparatus of claim 1, wherein the circuit is configured to switch off the operating voltage of the memory based on a reset signal generated by the computer.

8. The apparatus of claim 1, wherein the circuit is configured to switch off the operating voltage of the memory based on a first reset signal generated by a first monitoring chip monitoring a cold start of the computer, based on a second reset signal generated by a second monitoring chip monitoring a warm start of the computer, and based on a third reset signal generated by the computer.

9. The apparatus of claim 8, wherein the circuit comprises a switching element configured to switch off the operating voltage of the memory when the first reset signal has a negative logic signal level, when the second reset signal has a negative logic signal level, or when the third reset signal has a positive logic signal level.

10. The apparatus of claim 9, wherein the switching element is configured as a p-channel metal-oxide semiconductor (pMOS) transistor.

11. The apparatus of claim 10, wherein the circuit comprises:
a first input node for receiving the first reset signal;
a first pull-up resistor coupled between the first input node and an operating voltage node; and
a second pMOS transistor,
wherein a gate connection of the second pMOS transistor is connected to the first input node,
wherein a source connection of the second pMOS transistor is connected to the operating voltage node, and
wherein a drain connection of the second pMOS transistor is connected to the gate connection of the first pMOS transistor.

12. The apparatus of claim 11, wherein the circuit further comprises:
a second input node for receiving the second reset signal;
a second pull-up resistor coupled between the second input node and the operating voltage node; and
a third pMOS transistor,
wherein a gate connection of the third pMOS transistor is connected to the second input node,
wherein a source connection of the third pMOS transistor is connected to the operating voltage node, and
wherein a drain connection of the third pMOS transistor is connected to the gate connection of the first pMOS transistor.

13. The apparatus of claim 12, wherein the circuit further comprises:
a third input node for receiving the third reset signal;
a pull-down resistor coupled between the third input node and ground; and
a series resistor coupled between the third input node and the gate connection of the first pMOS transistor.

14. An embedded system comprising:
an apparatus for processing data, the apparatus comprising:
a computer bootable by a particular boot block for processing the data;
a memory operable by an operating voltage, the memory being configured to store at least the particular boot block for booting the computation apparatus; and
a circuit configured to switch off the operating voltage of the memory based on at least one reset signal prompting a reset of the computer.

15. A method for operating an apparatus for processing data, wherein the apparatus comprises a computer that is bootable by a particular boot block for processing the data, and a memory operable by an operating voltage for storing at least the particular boot block for booting the computer, the method comprising:
switching off the operating voltage of the memory based on at least one reset signal prompting a reset of the computer.

16. The embedded system of claim 14, wherein the computer is a field-programmable gate array (FPGA), a system on a chip (SOC) FPGA, or a central processing unit (CPU).

17. The embedded system of claim 14, wherein the memory is a flash memory, a QSPI flash memory, a solderable micro-SD memory, or an embedded MultiMediaCard (eMMC) memory.

18. The embedded system of claim 14, wherein the memory is a quad serial peripheral interface (QSPI) flash memory without a reset input.
